(19) United States
(12) Patent Application Publication
(10) Pub. No.: US 2024/0218145 A1
(43) Pub. Date: Jul. 4, 2024

(54) Method For Preparing Recycled Polycarbonate And Recycled Polycarbonate

(71) Applicant: LG Chem, Ltd., Seoul (KR)

(72) Inventors: Seog Jae Seo, Daejeon (KR); Gyoungsik Kim, Daejeon (KR); Gyeongho Seon, Daejeon (KR); Chang Hwan Ju, Daejeon (KR); Danbi Han, Daejeon (KR); Jae Hoon Choe, Daejeon (KR)

(73) Assignee: LG Chem, Ltd., Seoul (KR)

(21) Appl. No.: 18/289,073

(22) PCT Filed: Sep. 29, 2022
(86) PCT No.: PCT/KR2022/014709

§ 371 Date: Oct. 31, 2023

(30) Foreign Application Priority Data
Oct. 18, 2021 (KR) 10-2021-0138175

(51) Int. Cl. C08J 11/08; C08L 69/00

(52) U.S. Cl. CPC C08J 11/08; C08L 69/00; C08J 2369/00; C08L 2207/20

(57) ABSTRACT

A method for preparing recyclable polycarbonate and recyclable polycarbonate are described herein, and the method comprises using a phenol end-capper.

### CROSS-REFERENCE TO RELATED APPLICATIONS

The present specification is a national stage entry under 35 U.S.C. § 371 of International Application No. PCT/KR2022/014709 filed on Sep. 29, 2022, which claims priority from Korean Patent Application No. 10-2021-0138175 filed on Oct. 18, 2021, all the disclosures of which are incorporated by reference herein.

### TECHNICAL FIELD

The present disclosure relates to a method for preparing recyclable polycarbonate and recyclable polycarbonate prepared thereof, and more particularly, to a method for preparing recyclable polycarbonate using a phenol end-capper.

### BACKGROUND ART

Since plastics are readily processed and their physical and chemical properties are easily changed, plastics are widely used in modern society. Among them, polycarbonate is one of the plastics that are widely used in various machines or electrical products due to its excellent mechanical properties such as insulation, impact resistance, and processability. Although landfill and incineration methods are frequently used to process waste plastic discarded after use, it is difficult to naturally decompose plastics, so that when landfilled, plastics may cause environmental problems such as water and soil pollution and may cause environmental problems such as air pollution when incinerated.

In order to solve such environmental problems, many studies have been conducted to process, purify, transform and recycle waste plastics, and some of the recycling methods have been put to practical use. However, since there is a disadvantage in that the unit cost of plastics recycled by the recycling method is high and the purity of the plastics cannot be significantly improved, the recycled plastic cannot be used in many applications. Further, it is difficult to process and purify recycled plastics because waste plastics with various colors are mixed, so that there is a disadvantage in that it is difficult to specify the desired physical and chemical properties and to implement colors.

Therefore, there is a continuous need for research on a method for preparing recyclable plastics capable of preventing deterioration in mechanical properties while significantly increasing the purity of recycled plastics.

### Related Art Document

Korean Patent No. 10-2192506

### Technical Problem

The present disclosure has been made in an effort to provide a method for preparing recyclable polycarbonate capable of preventing deterioration in mechanical properties and significantly increasing the purity of recycled polycarbonate, and recyclable polycarbonate prepared thereof.

### Technical Solution

An exemplary embodiment of the present invention provides a method for preparing recyclable polycarbonate, the method including: preparing a first solution by dissolving waste polycarbonate in a solvent; preparing a second solution by adding a phenol end-capper to the first solution; removing impurities from the second solution by adding an adsorbent to the second solution; precipitating a polycarbonate resin by adding a non-solvent to the second solution from which the impurities have been removed; and collecting the precipitated polycarbonate resin.

Another exemplary embodiment of the present invention provides recyclable polycarbonate prepared by the method for preparing recyclable polycarbonate.

### Advantageous Effects

The recyclable polycarbonate prepared by the method for preparing recyclable polycarbonate of the present disclosure does not deteriorate in mechanical properties, has high purity, and effectively suppresses yellowing.

### BRIEF DESCRIPTION OF DRAWINGS

FIG. 1 illustrates the results of 1H-NMR analysis of the recyclable polycarbonate of Comparative Example 1.

FIG. 2 illustrates the results of 1H-NMR analysis of the recyclable polycarbonate prepared by the method for preparing recyclable polycarbonate of the present disclosure.

### DETAILED DESCRIPTION

Hereinafter, specific exemplary embodiments will be described in more detail.

An exemplary embodiment of the present invention provides a method for preparing recyclable polycarbonate, the method including: preparing a first solution by dissolving waste polycarbonate in a solvent; preparing a second solution by adding a phenol end-capper to the first solution; removing impurities from the second solution by adding an adsorbent to the second solution; precipitating a polycarbonate resin by adding a non-solvent to the second solution from which the impurities have been removed; and collecting the precipitated polycarbonate resin.

Polycarbonate is one of the plastics that are widely used in various machines or electrical products due to its excellent mechanical properties such as insulation, impact resistance, and processability. When the backbone of polycarbonate degrades upon exposure to UV light, oxygen (02) or heat, fragments having ends of phenol, aldehyde or benzyl alcohol may be produced. Among them, phenol may cause yellowing during the extrusion or injection process when recyclable polycarbonate is prepared from waste polycarbonate, and may cause deterioration in mechanical properties.

The method for preparing recyclable polycarbonate according to the present disclosure may effectively prevent the deterioration in mechanical properties and the yellowing phenomenon which may occur upon the preparation of recyclable polycarbonate by protecting phenol end groups present in the backbone of waste polycarbonate with a phenol end-capper.

In an exemplary embodiment of the present invention, the phenol end-capper is an anhydride or acyl halide.

In an exemplary embodiment of the present invention, the phenol end-capper is an anhydride.

In an exemplary embodiment of the present invention, the anhydride is acetic anhydride or benzoic anhydride.

In an exemplary embodiment of the present invention, the phenol end-capper is an acyl halide.

In an exemplary embodiment of the present invention, the acyl halide is benzoyl chloride or 2,2-dimethylpropanoyl chloride.

In an exemplary embodiment of the present invention, the adsorbent is a combination of one or more selected from the group consisting of silica, alumina, activated carbon, acid clay, magnesium silicate and aluminosilicate.

The adsorbent is specifically acid clay.

In an exemplary embodiment of the present invention, the adsorbent is included in an amount of 0.1 parts by weight to 5 parts by weight based on the total weight of 100 parts by weight of the second solution.

When the adsorbent is included in the second solution within the above-described range, impurities included in the second solution may be effectively removed.

In an exemplary embodiment of the present invention, the solvent is a cyclic ether-based solvent, a linear or cyclic carbonate-based solvent, a hydrocarbon solvent having 1 to 8 carbon atoms, which includes one or more halogens, methylpyrrolidone, dimethylformamide or dimethyl sulfoxide.

In an exemplary embodiment of the present specification, the cyclic ether-based solvent may be tetrahydrofuran, 1,4-dioxane or 1,3-dioxolane. In an exemplary embodiment of the present invention, the linear carbonate-based solvent may be dimethyl carbonate (DMC), diethyl carbonate (DEC), dipropyl carbonate (DPC), ethylpropyl carbonate (EPC), ethylmethyl carbonate (EMC) or methylpropyl carbonate (MPC), but is not limited thereto.

In an exemplary embodiment of the present invention, the cyclic carbonate-based solvent may be ethylene carbonate (EC), propylene carbonate (PC), 1,2-butylene carbonate (BC), 2,3-butylene carbonate, 1,2-pentylene carbonate, 2,3-pentylene carbonate, vinylene carbonate (VC), vinyl ethylene carbonate or fluoroethylene carbonate, but is not limited thereto. Preferably, the cyclic carbonate-based solvent may be propylene carbonate.

In an exemplary embodiment of the present invention, the hydrocarbon solvent having 1 to 8 carbon atoms, which includes one or more halogens, may be dichloromethane, chloroform, tetrachloroethane or ethylene dichloride, but is not limited thereto.

In the present disclosure, the solvent may be preferably dichloromethane.

In the present disclosure, the non-solvent is a hydrocarbon compound including one or more selected from the group consisting of an alcohol, ketone, ether, a cycloalkane, ester, carboxylic acid and a nitrile group.

The non-solvent means a compound having a Hansen solubility parameter (HSP) of 5 to 14 with respect to the polycarbonate.

The Hansen solubility parameter with respect to the polycarbonate may be specifically calculated from non-polar dispersion force, dipole-dipole force due to permanent dipole, and hydrogen bonding force, in consideration of the degree of intra-material bonding of the polycarbonate.

Specifically, the compound having a Hansen solubility parameter (HSP) of 5 to 14 with respect to the polycarbonate is a hydrocarbon compound having 1 to 10 carbon atoms, which includes one or more of an alcohol, ketone, ether, a cycloalkane, ester, carboxylic acid or a nitrile group.

More specifically, the compound having a Hansen solubility parameter (HSP) of 5 to 14 with respect to the polycarbonate is a hydrocarbon compound having 1 to 5 carbon atoms, which includes one or more of an alcohol, ketone, ester or a nitrile group.

In an exemplary embodiment of the present invention, the non-solvent is acetone.

In an exemplary embodiment of the present invention, a catalyst may be further added to the first solution.

The catalyst may promote the esterification reaction of a phenol end group included in the waste polycarbonate under mild conditions such as room temperature.

The catalyst may be 4-(N,N-dimethylamino)pyridine (DMAP), 4-(N,N-dimethylamino)pyridine hydrochloride (DMAP·HCl), copper (II) tetrafluoroborate or Cu(OTf)₂, but is not limited thereto.

Preferably, the catalyst may be Cu(OTf)₂.

In an exemplary embodiment of the present invention, the phenol end-capper is included in an amount of 0.1 parts by weight to 5 parts by weight based on the total weight of 100 parts by weight of the first solution.

Preferably, the phenol end-capper is included in an amount of 0.1 parts by weight to 1 part by weight based on the total weight of 100 parts by weight of the first solution.

When the phenol end-capper is included in the first solution within the above-described range, the phenol end-capper may be sufficiently reacted with phenol end groups included in the waste polycarbonate.

In an exemplary embodiment of the present invention, the collecting of the precipitated polycarbonate resin includes: separating the precipitated polycarbonate resin with a filter; washing the precipitated polycarbonate resin; and drying the precipitated polycarbonate resin.

In the separating of the precipitated polycarbonate resin with the filter, the mesh of the filter may be 1 μm to 10 μm.

Preferably, the mesh of the filter may be 3 μm to 7 μm.

In the washing of the precipitated polycarbonate resin, the precipitated polycarbonate resin may be washed using acetone. Specifically, the separated polycarbonate resin may be washed twice using 1 L of acetone.

In the drying of the precipitated polycarbonate resin, the precipitated polycarbonate resin may be dried in a vacuum oven at 40° ° C. for 16 hours.

An exemplary embodiment of the present invention provides recyclable polycarbonate prepared by the method for preparing recyclable polycarbonate.

In an exemplary embodiment of the present invention, the phenol content of the recyclable polycarbonate is 0.5 mol % or less.

As the phenol content of the recyclable polycarbonate is decreased, a good-quality recyclable polycarbonate may be obtained, and the phenol content of the recyclable polycarbonate is preferably 0.2 mol % or less, more preferably the NMR detection limit or less.

In an exemplary embodiment of the present invention, the lower the phenol content of the recyclable polycarbonate is, the more desirable the recyclable polycarbonate is, so that the lower limit is not particularly limited, but may be, for example, 0.001 mol % or more

When the phenol content of the recyclable polycarbonate satisfies the above-described range, the content of phenol included in the recyclable polycarbonate is very small, so that yellowing caused by phenol may be prevented. The degree of yellowing varies depending on the phenol content, and preferably when the phenol is reduced below the NMR detection limit, the yellowing phenomenon is reduced the most.

The phenol content of the recyclable polycarbonate may be calculated using 1H-NMR analysis. Specifically, the phenol content may be measured by adding trimethylsilane (TMS) as an internal standard, dissolving recyclable polycarbonate in a CDCl₃ solvent at 20 mg/ml, and then using Agilent 500 MHz equipment. For a peak area of 7.18 ppm in the measured 1H-NMR, 4H of the phenyl group of polycarbonate is employed as a reference, and the peak areas seen at 6.71 ppm and 4.74 ppm are specified to a phenyl group (2H) and a hydroxyl group (1H) of the phenol, respectively to convert the content of phenol present in the recyclable polycarbonate backbone into mol %.

In an exemplary embodiment of the present invention, the yellow index (YI) of the recyclable polycarbonate is 2.5 or less.

Specifically, the yellow index (YI) of the recyclable polycarbonate is 1 or more and 2.4 or less, 1.5 or more and 2.35 or less, or 1.95 or more and 2.34 or less.

When the yellow index of the recyclable polycarbonate satisfies the above-described range, it can be confirmed that the yellowing phenomenon of the recyclable polycarbonate is prevented.

The yellow index of the recyclable polycarbonate may be measured by injection molding a sample (width/height/thickness=60 mm/40 mm/3 mm) at 270° ° C. in accordance with ASTM D1925.

In an exemplary embodiment of the present invention, the weather resistance (ΔE) of the recyclable polycarbonate is 20 or less.

The yellowing phenomenon of the recyclable polycarbonate means the weather resistance measurement.

After L, a and b values are measured by the ASTM D7869 method, the corresponding sample is allowed to stand under the weather resistance conditions of 2,250 hr using a Weather-Ometer® machine, and then the weather resistance (ΔE) can be calculated by the following Equation 2 from L′, a′ and b′ values measured again.

$$Δ E = \sqrt{( {( {L}^{′} - L )}^{2} + {( {a}^{′} - a )}^{2} + {( {b}^{′} - b )}^{2} )} \qquad [ Equation 2 ]$$

In an exemplary embodiment of the present invention, the weather resistance (ΔE) of the recyclable polycarbonate is 20 or less, and may be preferably 16 or less, 15.5 or less, 15.2 or less or 10 or less.

The lower the weather resistance (ΔE), the more preferable the weather resistance (ΔE), so that the lower limit thereof is not particularly limited, but may be, for example, 5 or more, 6 or more, or 8 or more.

In an exemplary embodiment of the present invention, the weight average molecular weight (Mw) of the recyclable polycarbonate is 42,000 g/mol or more and 44,000 g/mol or less, but is not limited thereto.

More specifically, the recyclable polycarbonate has a weight average molecular weight of 42,500 g/mol or more and 43,400 g/mol or less.

The weight average molecular weight may be measured by calibrating with a PC standard using Agilent 1200 series.

In an exemplary embodiment of the present invention, the recyclable polycarbonate may have a melt index (MI) of 15 to 25. Specifically, the recyclable polycarbonate may have a melt index of 20 to 21.

The melt index may be measured at 300° C. using a 1.2 kg weight in accordance with ASTM D1238.

In an exemplary embodiment of the present invention, the waste polycarbonate is included in an amount of 2 parts by weight to 20 parts by weight based on the total weight of 100 parts by weight of the first solution.

In an exemplary embodiment of the present invention, the solvent is included in an amount of 80 parts by weight to 90 parts by weight based on the total weight of 100 parts by weight of the first solution.

When the waste polycarbonate and the solvent are included in the first solution within the above-described range, the waste polycarbonate is not precipitated, and the first solution may be appropriately prepared.

In an exemplary embodiment of the present invention, in the preparing of the first solution by dissolving the waste polycarbonate in the solvent, the waste polycarbonate is dissolved in the solvent for 1 hour to 3 hours.

Specifically, the waste polycarbonate is dissolved in the solvent for 1 hour and 30 minutes to 2 hours and 30 minutes, preferably 2 hours.

When the waste polycarbonate is dissolved in an organic solvent for 1 hour to 3 hours as described above, the waste polycarbonate is not dissolved while swelling on the surface of the solvent, and is well dissolved in the solvent, so that the first solution may be properly prepared.

In an exemplary embodiment of the present invention, the preparing of the first solution by dissolving the waste polycarbonate in the solvent may be performed at room temperature. Specifically, the preparing of the first solution by dissolving the waste polycarbonate in the solvent may be performed at a temperature of 15° ° C. to 25° C. When the waste polycarbonate is dissolved in the solvent at a temperature of 15° C. to 25° ° C. as described above, the degree of vaporization of the solvent is low, so that the desired first solution may without be prepared significantly changing the concentration of the solution.

In an exemplary embodiment of the present invention, the method for preparing recyclable polycarbonate may further include preparing the first solution, and then filtering the first solution with a filter. The filter may have a mesh of 0.45 μm to 10 μm.

In an exemplary embodiment of the present invention, the non-solvent is included in an amount of 30 parts by weight to 500 parts by weight based on the total weight of 100 parts by weight of the second solution.

When the non-solvent is included in the second solution within the above-described range, impurities such as an antioxidant or heat stabilizer may be effectively removed from the waste polycarbonate, and recyclable polycarbonate with a high yield may be obtained.

The impurities mean organic and inorganic dyes or pigments, heat stabilizers, antioxidants, UV stabilizers, flame retardants, antistatic agents, impact modifiers, plasticizers, glidants, or the like other than polymer compounds added during the preparation of polycarbonate, and are not limited thereto, and may mean all additives for preparing polycarbonate used in the art.

The antioxidant may be, for example, an Irgafos antioxidant, and the heat stabilizer may be, for example, a Tinuvin heat stabilizer.

The collecting of the precipitated polycarbonate resin means filtering out the precipitated polycarbonate resin by filtering a solution obtained by adding a non-solvent to the second solution with a filter.

In this case, in the separating of the precipitated polycarbonate resin with the filter, the mesh of the filter may be 1 μm to 10 μm, but is not limited thereto.

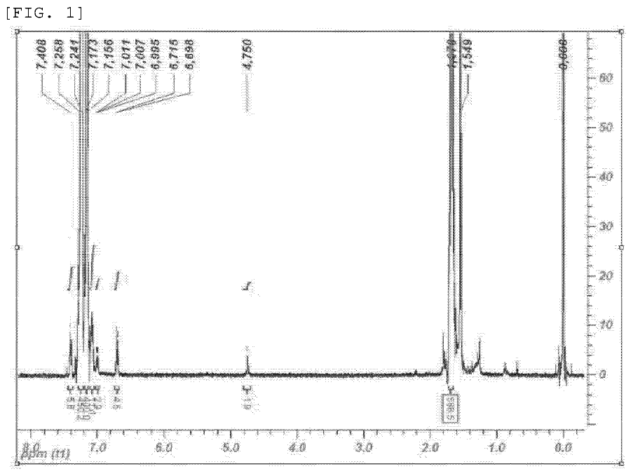

FIG. 1 illustrates the results of 1H-NMR analysis of the recyclable polycarbonate of Comparative Example 1 in which the phenol end-capper treatment is not performed. In FIG. 1, the phenyl group peaks of 7.26 ppm and 7.18 ppm corresponding to polycarbonate and the methyl group peak of 1.68 ppm appear large, and 6.74 ppm (2H) and 4.74 ppm (1H) corresponding to the end group of phenol are observed. Phenyl (2H) in the phenol end group overlapped with the polycarbonate peaks, and thus could not be specified.

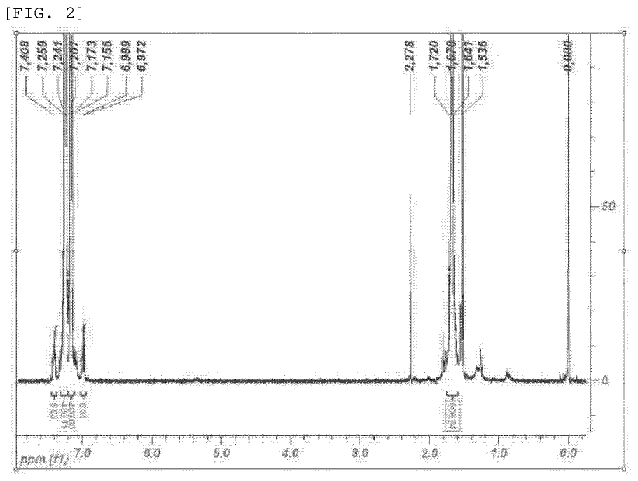

FIG. 2 illustrates the results of 1H-NMR analysis of the recyclable polycarbonate prepared by the method for preparing recyclable polycarbonate of the present disclosure. In FIG. 2, it can be observed that 6.74 ppm (2H) and 4.74 ppm (1H) corresponding to the phenol end group significantly decrease.

Hereinafter, the present disclosure will be exemplified in more detail through Examples. The present disclosure is not limited to these Examples, the Examples according to the present disclosure may be modified in various forms, and it should not be interpreted that the scope of the present disclosure is limited to the Examples to be described in detail below. The Examples of the present disclosure are provided for more completely explaining the present disclosure to a person with ordinary skill in the art.

### EXAMPLES AND COMPARATIVE EXAMPLES

### Example 1

A first solution was prepared by adding 360 g of waste polycarbonate to 2,040 g of a solvent dichloromethane in a reactor at room temperature)(20° ° C. to dissolve the waste polycarbonate for 2 hours.

2.56 g of a catalyst Cu(Otf)₂ was added to the first solution and the resulting mixture was stirred at 300 rpm for 30 minutes.

Thereafter, a second solution was prepared by slowly introducing 7.23 g of acetic anhydride, which is a phenol end-capper, into the first solution and stirring the resulting mixture at room temperature (20° C.) and 300 rpm for 6 hours.

18 g of acid clay as an adsorbent was added to the second solution to remove impurities from the first solution, and the adsorbent-added first solution was filtered using a 1 μm-mesh filter to remove the adsorbent and impurities.

A polycarbonate resin was precipitated by slowly introducing 2,400 ml of acetone, which is a non-solvent, into the first solution. The precipitated polycarbonate resin was collected by filtering with a 5-μm mesh paper filter and washed twice with 1,000 ml of acetone.

Thereafter, 298 g of recyclable polycarbonate was obtained by drying the precipitated polycarbonate resin in a vacuum oven at 40ºC for 16 hours. (Yield of 83% compared to waste polycarbonate input)

### Example 2

305 g of recyclable polycarbonate was obtained in the same manner as in Example 1, except that 16.03 g of benzoic anhydride was applied as a phenol end-capper in Example 1. (Yield of 85% compared to waste polycarbonate input)

### Example 3

292 g of recyclable polycarbonate was obtained in the same manner as in Example 1, except that 2.25 g of 4-(N,N-dimethylamino)pyridine HCl) was used as a catalyst in Example 1. (Yield of 81% compared to waste polycarbonate input)

### Example 4

295 g of recyclable polycarbonate was obtained in the same manner as in Example 2, except that 2.25 g of 4-(N,N-dimethylamino)pyridine HCl) was used as a catalyst in Example 2. (82% compared to waste polycarbonate input)

### Example 5

305 g of recyclable polycarbonate was obtained in the same manner as in Example 3, except that 9.96 g of benzoic anhydride was applied as a phenol end-capper in Example 3. (Yield of 85% compared to waste polycarbonate input)

### Example 6

288 g of recyclable polycarbonate was obtained in the same manner as in Example 3, except that 8.54 g of 2,2-dimethylpropanoyl chloride was applied as a phenol end-capper in Example 3. (Yield of 80% compared to waste polycarbonate input)

### Comparative Example 1

A first solution was prepared by adding 360 g of waste polycarbonate to 2,040 g of a solvent dichloromethane in a reactor at room temperature (20° C.) to dissolve the waste polycarbonate for 2 hours.

18 g of acid clay as an adsorbent was added to the first solution to remove impurities from the first solution, and the adsorbent-added first solution was filtered using a 1 μm-mesh filter to remove the adsorbent and impurities.

Thereafter, a polycarbonate resin was precipitated by slowly introducing 2,400 ml of acetone, which is a non-solvent, into the first solution. The precipitated polycarbonate resin was collected by filtering with a 5-μm mesh paper filter and washed twice with 1,000 ml of acetone.

Thereafter, 302 g of recyclable polycarbonate was obtained by drying the precipitated polycarbonate resin in a vacuum oven at 40ºC for 16 hours. (Yield of 84% compared to waste polycarbonate input)

### Experimental Example

The recyclable polycarbonates prepared in the Examples and the Comparative Example were analyzed as follows, and the analysis results are shown in the following Table 1.
Weight average molecular weight (Mw): measured by calibrating with a PC standard using Agilent 1200 series.
Melt index (MI): measured at 300° ° C. using a 1.2 kg weight in accordance with ASTM D1238.
Measurement of phenol content according to 1H-NMR analysis: measured by adding trimethylsilane (TMS) as an internal standard, dissolving recyclable polycarbonate in a CDCl₃ solvent at 20 mg/ml, and then using Agilent 500 MHZ equipment.

Specifically, for a peak area of 7.18 ppm in the measured NMR, 4H of the phenyl group of polycarbonate is employed as a reference, and the peak areas seen at 6.71 ppm and 4.74 ppm are specified to a phenyl group (2H) and a hydroxyl group (1H), respectively to convert the content of phenol present in the recyclable polycarbonate backbone into mol %. The area proportion of 6.71 ppm (2H) of the phenyl peak at the end group of phenol was calculated based on the 7.18 ppm (4H) of the phenyl peak of polycarbonate. The width proportion was converted into the number of protons and shown as a percentage. When width proportion is represented by Equation 1, it will be as follows.

$$mol \% = \frac{Area ( peak , 6.71 ppm )}{Area ( peak , 7.18 ppm )} \times \frac{4 ( 4 H , ph )}{2 ( 2 H , ph )} \times 100 ( \% ) \qquad [ Equation 1 ]$$

Yellow Index (YI): YI values were measured by injection molding a sample (width/height/thickness=60 mm/40 mm/3 mm) at 270° C. in accordance with ASTM D1925.
Weather resistance (ΔE): after L, a and b values are measured by the ASTM D7869 method, the corresponding test specimen is allowed to stand under the weather resistance conditions of 2,250 hr using a Weather-Ometer® machine, and then the weather resistance (ΔE) can be calculated by the following Equation 2 from L′, a′ and b′ values measured again.

$$Δ E = \sqrt{( {( {L}^{′} - L )}^{2} + {( {a}^{′} - a )}^{2} + {( {b}^{′} - b )}^{2} )} \qquad [ Equation 2 ]$$

TABLE 1

| | | | Phenol | | |
|---|---|---|---|---|---|
| | Mw | MI | content | | |
| | (g/mol) | (g/10 min) | (mol %) | YI | ΔE |
| Example 1 | 43,300 | 20 | 0.14 | 1.99 | 7.7 |
| Example 2 | 43,400 | 20 | 0.13 | 2.07 | 9.6 |
| Example 3 | 42,500 | 20 | 0.29 | 2.34 | 15.2 |
| Example 4 | 42,500 | 20 | 0.20 | 2.12 | 12.8 |
| Example 5 | 42,600 | 21 | 0.21 | 1.95 | 6.1 |
| Example 6 | 43,000 | 19 | 0.33 | 2.01 | 7.0 |
| Comparative | 42,400 | 20 | 2.24 | 3.67 | 23.7 |
| Example 1 | | | | | |

As can be seen from the results in Table 1, it was confirmed that the recyclable polycarbonates of Examples 1 to 6, prepared by the method for preparing recyclable polycarbonate according to the present disclosure, had significantly lower phenol contents, lower yellow index (YI) values and lower weather resistance (ΔE) than the Comparative Example, and thus can effectively prevent the yellowing phenomenon.

Meanwhile, the weight average molecular weight and melt index values of Examples 1 to 6 are not significantly different from those of Comparative Example 1, confirming that the physical properties of weight average molecular weight and melt index are not changed because the backbone of the polycarbonate is not decomposed.

1. A method for preparing a recyclable polycarbonate, the method comprising:
preparing a first solution by dissolving a waste polycarbonate in a solvent;
preparing a second solution by adding a phenol end-capper to the first solution;
removing impurities from the second solution by adding an adsorbent to the second solution;
precipitating a polycarbonate by adding a non-solvent to the second solution from which the impurities have been removed; and
collecting the precipitated polycarbonate.

2. The method of claim 1, wherein the phenol end-capper is an anhydride or acyl halide.

3. The method of claim 1, wherein the adsorbent is at least one selected from the group consisting of silica, alumina, activated carbon, acid clay, magnesium silicate and aluminosilicate.

4. The method of claim 1, wherein the adsorbent is comprised in an amount of 0.1 to 5 parts by weight based on a total weight of 100 parts by weight of the second solution.

5. The method of claim 2, wherein the anhydride is acetic anhydride or benzoic anhydride.

6. The method of claim 2, wherein the acyl halide is benzoyl chloride or 2,2-dimethylpropanoyl chloride.

7. The method of claim 1, wherein the solvent is a cyclic ether-based solvent, a linear or cyclic carbonate-based solvent, a hydrocarbon solvent having 1 to 8 carbon atoms, which comprises one or more halogens, methylpyrrolidone, dimethylformamide or dimethyl sulfoxide.

8. The method of claim 1, wherein the non-solvent is a hydrocarbon compound comprising one or more selected from the group consisting of an alcohol, a ketone, an ether, a cycloalkane, an ester, a carboxylic acid and or a nitrile-group.

9. The method of claim 1, wherein a catalyst is further added to the first solution.

10. The method of claim 1, wherein the phenol end-capper is comprised in an amount of 0.1 parts by weight to 5 parts by weight based on a total weight of 100 parts by weight of the first solution.

11. The method of claim 1, wherein the collecting of the precipitated polycarbonate comprises: separating the precipitated polycarbonate with a filter; washing the precipitated polycarbonate; and drying the precipitated polycarbonate.

12. The method of claim 1, wherein the waste polycarbonate is comprised in an amount of 2 parts by weight to 20 parts by weight based on a total weight of 100 parts by weight of the first solution.

13. The method of claim 1, wherein the non-solvent is comprised in an amount of 30 parts by weight to 500 parts by weight based on a total weight of 100 parts by weight of the second solution.

14. A recyclable polycarbonate prepared by the method of claim 1.

15. The recyclable polycarbonate of claim 14, which has a phenol content of 0.5 mol % or less.

16. The recyclable polycarbonate of claim 14, which has a yellow index (YI) of 2.5 or less.

17. The recyclable polycarbonate of claim 14, which has a weather resistance (ΔE) of 20 or less.

18. The method of claim 1, wherein the solvent is dichloromethane, and the non-solvent is acetone.

19. The method of claim 9, wherein the catalyst is 4-dimethylaminopyridine (DMAP), 4-dimethylaminopyridine hydrochloride (DMAP·HCl), copper (II) tetrafluoroborate or Cu(OTf)₂.

20. The method of claim 1, wherein the waste polycarbonate is dissolved in the solvent for 1 hour to 3 hours.
